(19) United States
(12) Patent Application Publication
(10) Pub. No.: US 2012/0206076 A1
(43) Pub. Date: Aug. 16, 2012

(54) MOTOR-DRIVING APPARATUS FOR VARIABLE-SPEED MOTOR

(76) Inventor: Shouichi Tanaka, Nagoya (JP)

(21) Appl. No.: 13/502,133

(22) PCT Filed: May 6, 2010
(86) PCT No.: PCT/JP2010/058138

§ 371 Date: Apr. 15, 2012

(30) Foreign Application Priority Data
Oct. 28, 2009 (JP) 2009-247454
Nov. 12, 2009 (JP) 2009-258614

(51) Int. Cl. H02P 6/14

(52) U.S. Cl. 318/400.28

(57) ABSTRACT

An object of the invention is to provide a motor-driving apparatus for driving a variable-speed motor, which increases a motor torque and efficiency at a high rotation speed. The motor-driving apparatus has a three-phase inverter and a boost DC/DC converter, which are operated the single-phase-switching method. The three-phase inverter consists of a nine-switch inverter applying the three-phase voltage to two three-phase windings of the motor. The single-phase-switching method reduces a switching power loss of the nine switch inverter largely. The boost DC/DC converter boosting a battery voltage reduces a copper loss of the inverter and the motor, too.

### CROSS-REFERENCE TO RELATED APPLICATION

This application claims benefit under 35 U.S.C. 119 of JP2009-247454 filed on Oct. 28, 2009, the title of POWER SWITCHING CIRCUIT and JP2009-258614 filed on Nov. 12, 2009, the title of POWER SWITCHING CIRCUIT the entire content of which is incorporated herein reference.

### BACKGROUND OF THE INVENTION

1. Field of the Invention

The document with the title, “Switching Loss Reduction Using a Single-Phase PWM Control Method, 4-029, IEE JAPAN, 2009” proposes a voltage type single-phase switching method (SPSM) shown in FIG. 1.

2. Description of the Related Art

The SPSM shown in FIG. 1 has a boost DC/DC converter 80 applying a periodically-changing voltage to the grid-connected three-phase inverter 40. The boost DC/DC converter 80 outputs a constant value of the electric power. Inverter 40 outputs a three-phase sinusoidal voltage having constant amplitude and a constant frequency to a grid network 200. The periodically-changing output voltage of the boost converter 80 is applied to the inverter 40. A DC power source 70 applies a DC voltage to a reactor 90 of the chopper type boost converter 80. Only one-phase leg of three-phase inverter 40 is PWM-switched. The other two legs are not PWM-switched. As the result, the switching power loss of the inverter is reduced. However, the above document does not describe to adopt the SPSM to drive a variable-speed three-phase motor. Because, a current of the motor, especially the variable-speed motor changes in a wide range. When the motor current is small, the inverter applies small amplitude of three-phase voltage. The SPSM with the three-phase inverter and the boost DC/DC converter can not apply such small voltage. Furthermore, the above SPSM reducing a switching power loss of the inverter requires the PWM-switched boost DC/DC converter. After all, a sum of the switching power loss of the inverter and the boost DC/DC converter are mostly equal to a conventional three-phase inverter driven with the spontaneous space vector method. Both have two PWM-switched half bridges. The motor-driving apparatus with the SPSM needs more production cost, because the SPSM requires the expensive boost DC/DC converter. Consequently, the idea about the motor-driving apparatus drive with the SPSM was not reasonable.

The variable speed motor such as a traction motor for driving an electric vehicle needs a wide rotation speed range, for example, from zero to more than 15000 rpm. Because a size and a weight of the motor can be decreased largely by employing the high rotation speed. However, a stator winding of the motor induces a high generation voltage at the high rotation speed. The generation voltage of the motor is proportional to the rotation speed of the motor. Specially, a synchronous motor with a permanent magnet rotor induces large amplitude of the generation voltage at a high rotation speed. Accordingly, the inverter must apply a high voltage to the motor at the high rotation speed for supplying the required motor current.

It is known to change turns of a motor winding in order to decrease the generation voltage of the motor at the high rotation speed. It is possible to reduce the generation voltage by means of decreasing the turns of the motor winding. A series-parallel-changing method is one of the turn-changing methods. However, the series-parallel-changing of the winding connection needs a complicated circuit of the motor-driving apparatus. The production cost and the power loss increase largely. Accordingly, it is difficult to employ the series-parallel-changing of the winding connection for the industrial motor or the vehicle motor.

### SUMMARY OF THE INVENTION

One object of the invention is to provide a motor-driving apparatus for driving a variable-speed motor, which increases a motor torque at a high rotation speed. Another object of the invention is to provide a motor-driving apparatus for driving a variable-speed motor, which has an excellent efficiency.

According to the first aspect of the invention, a boost DC/DC converter applies a biggest inter-phase voltage (Vx) between two legs of a three-phase nine-switch inverter. The PWM-switched other one leg of the three-phase nine-switch inverter outputs a smaller inter-phase voltage (Vy). The biggest inter-phase voltage (Vx) is larger than the smaller inter-phase voltage (Vx). The nine-switch inverter applies at least one three-phase sinusoidal voltage to two three-phase windings. By means of controlling of the nine switches of the inverter, the two three-phase windings are connected to series or connected in parallel. After all, it can be realized with less switching power loss to increase a motor torque at a high speed range.

According to a preferred embodiment, the boost DC/DC converter boosts a battery voltage applied from a vehicle battery and applies the boosted biggest inter-phase voltage (Vx) to the inverter driving the motor being a traction motor of a vehicle. The inverter driving the traction motor having a wide rotating speed range reduces own switching power loss. Furthermore, it is possible to reduce the battery voltage of the vehicle, because the boost DC/DC converter applies the boosted voltage to the motor via the inverter. Accordingly, the car maintenance becomes easy and safety, because the battery voltage can be decreased. In the other words, the vehicle traction apparatus, for example a hybrid car, generally employs the boost DC/DC converter for increasing the DC-link voltage applied to the inverter in order to avoid to increase the battery voltage. Consequently, the single-phase-switching method which needs the boost DC/DC converter can be realized without addition of the boost DC/DC converter.

According to the second aspect of the invention, a boost DC/DC converter applies a biggest inter-phase voltage (Vx) between two legs of a three-phase inverter. The PWM-switched other one leg of the three-phase inverter outputs a smaller inter-phase voltage (Vy). The biggest inter-phase voltage (Vx) is larger than the smaller inter-phase voltage (Vx). The inverter applies a three-phase voltage to a three-phase winding. The boost DC/DC converter controls amplitude and a waveform of the biggest inter-phase voltage (Vx) in accordance with a value of a motor current and a value of a rotor angle of the motor. As the result, it is realized largely to save a switching power loss of the inverter driving the variable-speed three-phase motor. In the other words, the variable-speed motor is driven with the single-phase-switching mode (SPSM) with the three-phase inverter and the boost DC/DC converter. As the result, the switching power loss of the inverter and a copper loss of the variable-speed three-phase motor can be reduced largely.

The biggest inter-phase voltage Vx is changed every 60 degrees in order. Only one leg of the three-phase inverter is switched with the PWM method. The PWM-switched leg is changed every 60 degrees of the electric angle in order. The other two fixed legs, which are half-bridges each, are not switched with the PWM method. A duty-increasing mode and a duty-decreasing mode are operated each 60 degrees of the electric angle alternatively for controlling of the PWM-switched leg. In the duty-increasing mode, the PWM duty ratio increases from 0% of to 100% successively. In a duty-decreasing mode, the PWM duty ratio decreases from 100% of to 0% successively. A pair of two legs for outputting the biggest inter-phase voltage Vx is changed every 60 degrees of the electric angle in order.

According to a preferred embodiment, the biggest inter-phase voltage (Vx) has a three-phase-full-wave-rectified wave form. The inverter outputs a three-phase sinusoidal voltage of which a frequency is changed in accordance with the rotation speed of the motor. Accordingly, vibration and noise of the noise are reduced, because the motor is driven with the three-phase sinusoidal voltage.

According to another preferred embodiment, the boost DC/DC converter consists of a chopper type DC/DC converter. The controller (9) changes a PWM duty ratio of the boost DC/DC converter (8) in the single-leg-switching mode in accordance with a received torque instruction value (Tr) and a detected rotation speed (ω) of the motor (6). As the result, the motor can have a preferable operation. Furthermore, the chopper-type boost DC/DC converter can charge the vehicle battery when the rotation speed is decreased.

According to another preferred embodiment, the controller has a table keeping a relation among the biggest inter-phase voltage (Vx), a rotor angle (θ), the torque instruction value (Tr) and the rotation speed (ω). The controller decides the biggest inter-phase voltage (Vx) in accordance with the received values of the detected values of the rotor angle (θ), the torque instruction value (Tr) and the rotation speed (ω). As the result, the variable speed motor employing the SPSM can generates a required torque value at a required rotation speed smoothly.

According to another preferred embodiment, the boost DC/DC converter boosts a battery voltage applied from a vehicle battery and applies the boosted biggest inter-phase voltage (Vx) to the inverter driving the motor being a traction motor of a vehicle. Accordingly, the switching power loss of the inverter and the copper loss of the motor can be reduced largely by means of the boosting of the battery voltage and employing of the SPSM. Furthermore, the vehicle traction apparatus, for example a hybrid car, generally employs the boost DC/DC converter in order to reduce the battery voltage, As the result, the motor-driving apparatus does not need to add the boost DC/DC converter in order to realize the SPSM.

According to another preferred embodiment, the motor has permanent magnets fixed to a rotor of the motor. The boost DC/DC converter applies the biggest inter-phase voltage (Vx), which is larger than a generation voltage of the motor (6), in the single-leg-switching mode. The motor current is reduced by an induced motor voltage increased at a high rotation speed range. The reduction of the motor current is large for the motor with permanent rotor. Accordingly, the boost ratio must be increased at the high rotation speed. However, an average motor current supplied by the inverter is reduced, because outputting periods of the boost DC/DC converter of the chopper type decreases. As the result, the motor torque is reduced at the high rotation speed.

It was found that the boost ratio of the boost DC/DC converter can be largely reduced in comparison with the conventional motor-driving apparatus with the boost DC/DC converter. As the result, a power loss of the boost DC/DC converter, which is proportional to the boost voltage of the boost DC/DC converter is reduced. Furthermore, the inverter and the converter can be made easy, because the voltage is applied to the inverter and the converter without reduction of the motor torque.

The reduction reason of the voltage is explained. The boost converter applies a biggest inter-phase voltage Vx to the three-phase inverter. The inter-phase voltage means a voltage between two phase voltages of the three-phase voltage. The conventional boost DC/DC converter must apply two times value of the biggest amplitude of one phase voltage.

The biggest inter-phase voltage Vx is smaller than two times value of the biggest amplitude of one phase voltage. Accordingly, the boost ratio of the boost DC/DC converter can be reduced about 15-20%. Furthermore, the voltage-outputting period of the boost converter increases, because the boost ratio is decreased. The motor torque of the variable-speed motor is proportional to a current supplied to the motor. Consequently, the variable speed motor can generate a strong torque at the high rotation speed range by employing the SPSM.

According to another preferred embodiment, the controller further has a plural-leg-switching mode for controlling the converter and the inverter. At least two legs are switched with a PWM method in the plural-leg-switching mode. The single-leg-switching mode is selected when the biggest inter-phase voltage (Vx) is larger than the battery voltage. The plural-leg-switching mode is selected when the biggest inter-phase voltage (Vx) is smaller than the battery voltage. The plural-leg-switching mode is essentially same as the conventional PWM-switched operation of the three-phase motor.

For example, one of the plural-leg-switching modes is the conventional three-phase PWM switching operation switching the three legs. Another one of the plural-leg-switching mode is a known two-phase modulation method or a known spontaneous space vector method. The two legs are PWM-switched. Consequently, the motor-driving apparatus can be driven even though the motor voltage must be smaller than the power source voltage by means of employing the known plural-leg-switching mode. As the result, the motor-driving apparatus with the SPSM can drive the motor at the low rotation speed with the small motor torque.

In another preferred embodiment, the PWM-switched leg is PWM-switched for outputting the smaller inter-phase voltage (Vy) while the boost converter outputs the biggest inter-phase voltage (Vx). The turning-on period of the upper switching element of the PWM-switched leg is shorter than the outputting period of the boost converter outputting the biggest inter-phase voltage (Vx). The PWM-switched leg is not turned on when the potential of the high potential bus line falls down. As the result, voltage ripples of the smaller inter-phase voltage (Vy) are reduced even though the capacitance of the smoothing capacitor is not large.

According to the third aspect of the invention, a nine-switch inverter drives two three-phase windings of the motor. each leg has three switches connected to series. By means of controlling of the nine switches of the inverter, the two three-phase windings are connected to series or connected in parallel. After all, it can be realized with less switching power loss to increase a motor torque at a high speed range.

According to a preferred embodiment, the nine-switch inverter changing the series connection to the parallel connection applies the two three-phase voltage to the traction motor driving wheels of a vehicle. Preferably, the motor torque can be changed by changing of the connection of the two three-phase windings.

According to a preferred embodiment, the nine-switch the two three-phase windings have a different turn number one another. As the result, the motor torque is changed by changing of the connection of the two three-phase windings.

According to a preferred embodiment, the first three-phase winding is wound around odd stator poles, and the second three-phase winding is wound around even stator poles. As the result, a pole number of the stator is changed, too. Preferably, the motor consists of an induction motor.

### BRIEF DESCRIPTION OF THE DRAWINGS

FIG. 1 is a block circuit diagram showing a prior grid-connected three-phase inverter operated with the SPSM.

FIG. 2 is a block circuit diagram showing a motor-driving apparatus driving a variable speed three-phase motor.

FIG. 3 is a schematic connection diagram showing six switching states of the three-phase inverter shown in FIG. 2.

FIG. 4 is a diagram showing a six gate voltage patterns in six stages of the three-phase inverter shown in FIGS. 2-3.

FIG. 5 is a timing chart showing one PWM-carrier period of the three-phase inverter shown in FIGS. 2-4.

FIG. 6 is a wave form of the three-phase voltage applied to the motor by the three-phase inverter shown in FIGS. 2-4.

FIG. 7 is a timing chart showing the biggest inter-phase voltage applied to the inverter by the converter shown in FIG. 2.

FIG. 8 is a block diagram of a controller controlling the three-phase inverter-converter shown in FIG. 2.

FIG. 9 is a vector diagram showing the biggest inter-phase voltage and a smaller inter-phase voltage.

FIG. 10 is a circuit diagram showing the stage when the converter outputs the biggest inter-phase voltage and the switched phase leg of the three-phase inverter is turned off.

FIG. 11 is a circuit diagram showing the stage when the converter outputs the biggest inter-phase voltage and the switched phase leg of the three-phase inverter is turned on.

FIG. 12 is a circuit diagram showing the stage when the converter does not output the biggest inter-phase voltage and the switched phase leg of the three-phase inverter is turned off.

FIG. 13 is a timing chart of the converter and the switched phase leg.

FIG. 14 is a timing chart of the converter and the switched phase leg.

FIG. 15 is another timing chart of the converter and the switched phase leg.

FIG. 16 is a timing chart showing an error-following PWM method as the one of the PWM method.

FIG. 17 is a circuit diagram operating the error-following PWM method.

FIG. 18 is a flow chart showing to control the operation of the variable speed motor.

FIG. 19 is a timing chart showing wave patterns from the converter shown in FIG. 2.

FIG. 20 is a circuit diagram showing three states of a nine-switch inverter driving a motor with two three-phase windings connected in parallel.

FIG. 21 is a circuit diagram showing three states of the nine-switch inverter driving a motor with two three-phase windings connected in parallel.

FIG. 22 is a circuit diagram showing four states of the nine-switch inverter driving a motor with two three-phase windings connected to series.

FIG. 23 is a circuit diagram showing four states of the nine-switch inverter driving a motor with two three-phase windings connected to series.

FIG. 24 is a circuit diagram showing four states of the nine-switch inverter driving a motor with two three-phase windings connected to series.

FIG. 25 is an equivalent circuit diagram showing the nine-switch inverter driving two three-phase windings connected in parallel.

FIG. 26 is an equivalent circuit diagram showing the nine-switch inverter driving two three-phase windings connected to series.

FIG. 27 is a schematic development showing a stator of a three-phase induction motor.

FIG. 28 is a schematic development showing a stator of a three-phase induction motor.

FIG. 29 is a schematic development showing a stator of a three-phase induction motor.

FIG. 30 is a schematic development showing a stator of a three-phase induction motor.

FIG. 31 is a circuit diagram showing four states of the nine-switch inverter driving two series-connected three-phase windings by the spontaneous space vector method.

FIG. 32 is a circuit diagram showing two states of the nine-switch inverter driving two series-connected three-phase windings by the spontaneous space vector method.

FIG. 33 is a timing chart showing one PWM-carrier period of the nine-switch inverter.

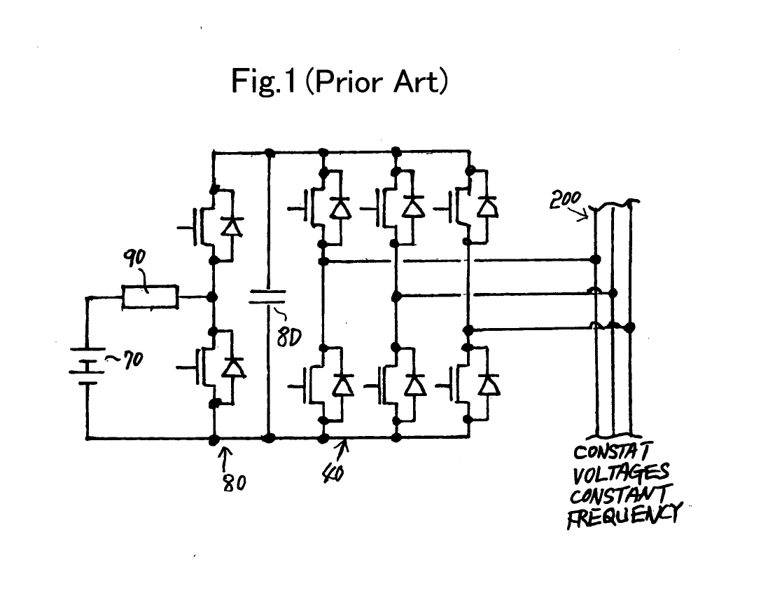

### PREFERRED EMBODIMENT OF THE INVENTION

### The Embodiment 1

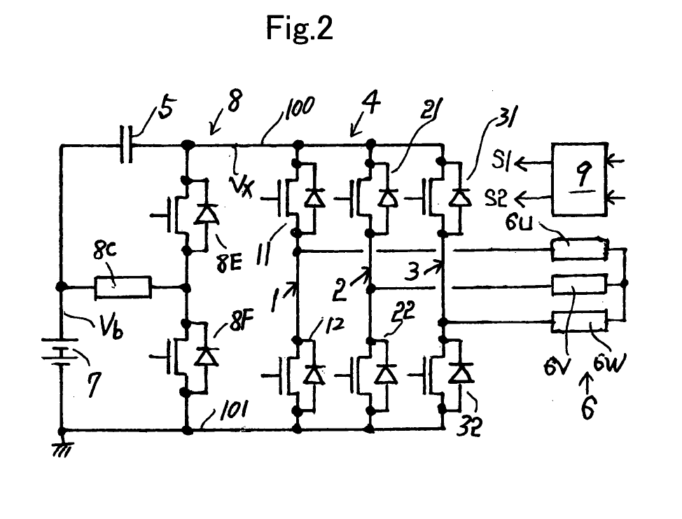

The SPSM-operated motor driving apparatus for driving a traction motor of an EV is explained referring to FIG. 2. The synchronous motor 6 with a three-phase stator winding has a permanent rotor. The motor-driving apparatus has a three-phase inverter 4, a smoothing capacitor 5, a chopper type boost DC/DC converter 8, and a controller 9. A battery voltage Vb of a battery 7 is applied to the converter 8. The inverter 4 outputs a three-phase voltage to the motor 6. The motor 6 has a U-phase winding 6U, a V-phase winding 6V and a W-phase winding 6W, which are connected with a Y-connection.

Three-phase inverter 4 has a U-phase leg 1, a V-phase leg 2 and a W-phase leg 3. Each of the legs 1-3 consists of a half-bridge. U-phase leg 1 has an upper switch 11 and a lower switch 12 connected to series. V-phase leg 12 has an upper switch 21 and a lower switch 22 connected to series. W-phase leg 3 has an upper switch 31 and a lower switch 32 connected to series. Each switch consists of a transistor and a free-wheeling diode connected in parallel one another. Three-phase inverter 4 drives the three-phase motor 6.

The boost DC/DC converter 8 changes a supplied battery voltage Vb to a periodically-changed DC-link voltage Vx, which is the biggest inter-phase voltage explained later. The converter 8 outputs the DC-link voltage Vx to the three-phase inverter 4 through a high potential bus line 100 and a low potential bus line 101. Converter 8 periodically changes amplitude of DC-link voltage Vx applied to the inverter 4.

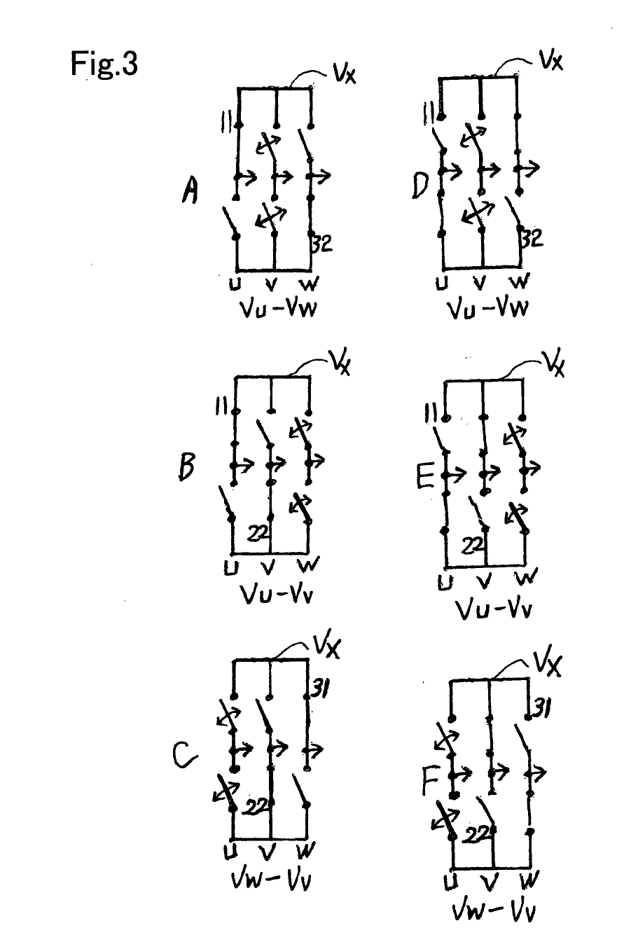

The SPSM operation of the inverter 4 is explained referring to FIG. 3. FIG. 3 shows stages A-F. An electric angle of 360 degrees is divided to six stages A-F. Each of the stages A-F has the electric angle of 60 degrees. One of the stages A-F is selected in accordance with a detected rotor angle in order.

In each of the stages A-F, four switches of two half-bridges keep a constant state. In the other words, two fixed legs are not PWM-switched. In each of stages A-F, only two switches of one half-bridge are PWM-switched to form a smaller inter-phase voltage (Vy) with the sin waveform. In the other words, one switched leg is not PWM-switched. In the following, the PWM-switched half bridge is called as the PWM-switched leg or the switched leg. Two the other half-bridges are called as the fixed legs.

V-phase leg 2 is the switched leg in the stages A and D. W-phase leg 3 is the switched leg in the stages B and E. U-phase leg 1 is the switched leg in the stages C and F as shown in FIG. 3. The upper switch and the lower switch of the switched leg are PWM-switched.

The upper switch 11 of U-phase leg 1 and the lower switch 32 of W-phase leg 3 are turned-on in the stage A. The biggest inter-phase voltage Vx is applied to U-phase winding 6U and W-phase winding 6W. In the stage A, U-phase leg 1 and W-phase leg 3 are the fixed legs.

Stages A-F are decided in accordance with a rotor angle detected by the rotor angle sensor (not shown). Instead of the detection of the rotor angle, stages A-F can be decided with induced phase voltages of phase windings 6U, 6V and 6W. If induced U-phase voltage is the highest, the stage is A or D. If induced V-phase voltage is the highest, the stage is B or E. If induced W-phase voltage is the highest, the stage is C or F.

In FIG. 3, U-phase leg 1 outputs U-phase voltage Vu. V-phase leg 2 outputs V-phase voltage Vv. W-phase leg 3 outputs W-phase voltage Vw. A voltage between two phase voltages selected among three phase voltages Vu, Vv and Vw is called the inter-phase voltage. The inter-phase voltage having the largest amplitude is called as the biggest inter-phase voltage Vx.

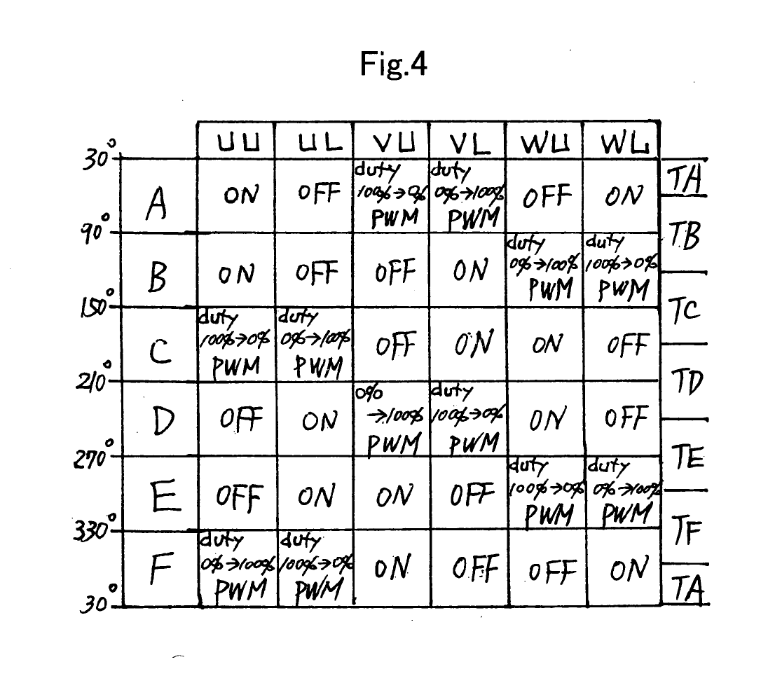

FIG. 4 shows the states of six switches 11-12, 21-22 and 31-32 of three-phase inverter 4 in the stages A-F. Gate voltage UU is applied to the switch 11. Gate voltage UL is applied to the switch 12. Gate voltage VU is applied to the switch 21. Gate voltage VL is applied to the switch 22. Gate voltage WU is applied to the switch 31. Gate voltage WL is applied to the switch 32. Each of the switches of the inverter 4 is PWM-switched for a period of only 60 degrees. In the next period of 120 degrees, the switches are turned off and radiated. Accordingly, the temperature-increasing of the switches is suppressed.

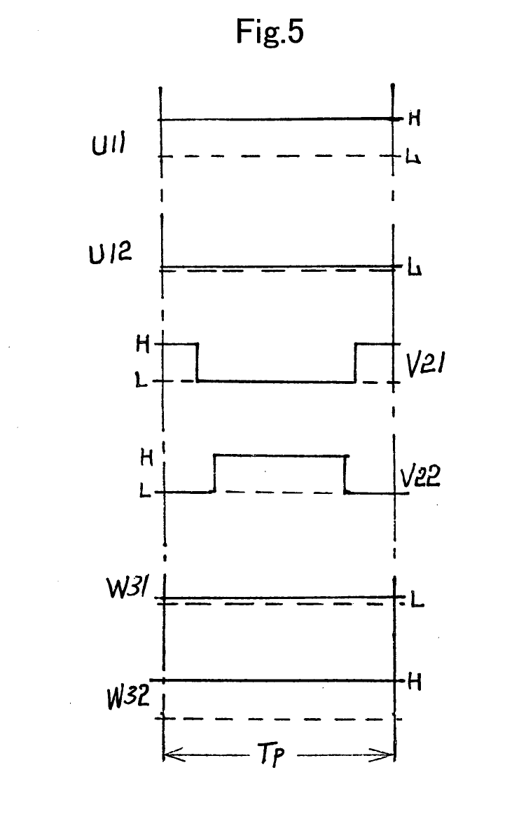

FIG. 5 shows wave forms of gate voltages applied to six switches of inverter 4 for one PWM-carrier period TP of the stage A. In one PWM-carrier-period TP, the switches 11 and 32 are turned on and the switches 12 and 31 are turned off. The switches 21 and 22 of V-phase leg are PWM-switched.

One of two switches of the PWM-switched leg has the duty ratio changing from 0% to 100% in the period of 60 degrees excessively. The other one of two switches of the PWM phase has the duty ratio changing from 100% to 0% in the period of the above 60 degrees excessively.

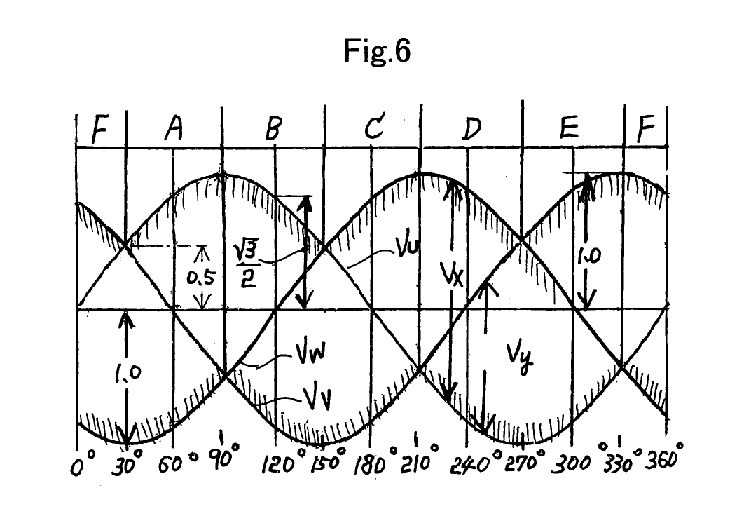

The SPSM operation of the converter 8 is explained referring to FIG. 2 and FIG. 6. FIG. 6 shows a three-phase sinusoidal wave voltage applied to motor 6. The converter 8 outputs DC-link voltage Vx, which is the biggest inter-phase voltage, to the inverter 4.

The boost operation of the chopper type boost converter 8 is well known. By turning-on of the lower switch 8F, the reactor 8C accumulates the magnetic energy. By turning-off of the lower switch 8F, the boost voltage is applied to the high potential bus line 100 through the switch 8E.

Smoothing capacitor 5 connects the high potential bus line 100 to a positive terminal of the battery 7. Smoothing capacitor 5 absorbs the surge energy when the upper switches 11, 21 and 31 are turned off. Furthermore, smoothing capacitor 5 reduces the voltage ripple of high potential bus line 100. However, a large capacitance of the smoothing capacitor 5 prevents the changing of the biggest inter-phase voltage Vx.

Controller 9 calculates a duty ratio Dx of the converter 8 in order to output the biggest inter-phase voltage Vx with the sinusoidal waveform in accordance with the detected rotor angle and an instruction value of an motor torque. Controller 9 can control the converter 8 with the well-known PWM feedback control method. Furthermore, controller 9 calculates the duty ratio Dy of the switched leg of inverter 4 in order to output the smaller inter-phase voltage Vy with the sin waveform in accordance with the detected rotor angle and the instruction value of the motor torque. The biggest inter-phase voltage Vx and the smaller inter-phase voltage Vy are shown in FIG. 6.

The biggest inter-phase voltage Vx is changed in each electrical angle of 60 degrees as shown in FIG. 6 in order. In the stage A from 30 degrees to 90 degrees, the biggest inter-phase voltage Vx is the inter-phase voltage Vu-Vw. In the stage B from 90 degrees to 150 degrees, the biggest inter-phase voltage Vx is the inter-phase voltage Vu-Vv. In the stage C from 150 degrees to 210 degree, the biggest inter-phase voltage Vx is the inter-phase voltage Vw-Vv.

In the stage D from 210 degrees to 270 degrees, the biggest inter-phase voltage Vx is the inter-phase voltage Vw-Vu. In the stage E from 270 degrees to 330 degrees, the biggest inter-phase voltage Vx is the inter-phase voltage Vv-Vu. In the stage F from 330 degrees to 30 degrees, the biggest inter-phase voltage Vx is the inter-phase voltage Vv-Vw.

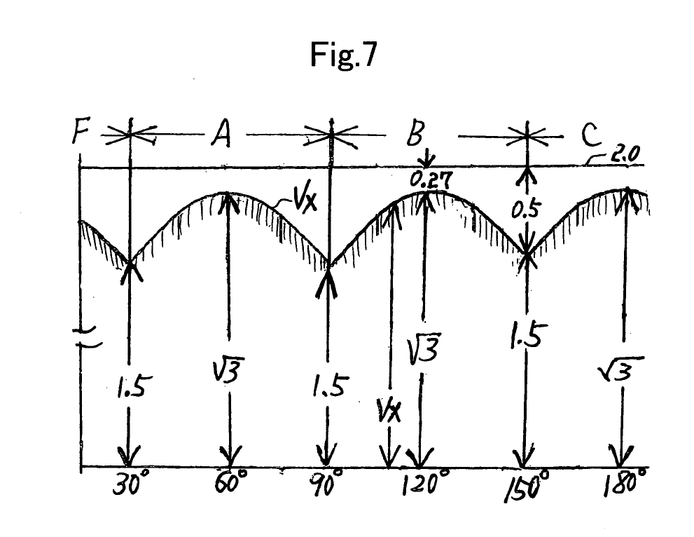

The biggest inter-phase voltage Vx has a waveform shown in FIG. 7. The waveform of the biggest inter-phase voltage Vx is equal to the full-wave-rectified waveform of the three-phase voltage. When the biggest value of one phase-voltage is 1, the value of the biggest inter-phase voltage Vx is 1.5-1.73.

A boost ratio of the converter 8 becomes 75-86.5% of the boost ratio of the conventional motor-driving apparatus with a converter and an inverter. As the result, the upper switch 8E of converter 8 can have higher duty ratio than the conventional motor-driving apparatus. For example, the converter of the conventional motor-driving apparatus outputs a boost voltage of 700 V, when a battery voltage Vb is 250V. The boost ratio becomes 2.8. On the other hand, the converter of the motor-driving apparatus of the embodiment outputs only 525-605V. Both of the apparatuses can apply an equal biggest inter-phase voltage Vx to the inverter 4. Accordingly, the converters of the both apparatuses have equal value of the output current. The boost voltage of the converter is reduced largely.

The biggest inter-phase voltage Vx has a part of sinusoidal waveform in each stage A-F. As the result, only one leg is PWM-switched for outputting the three-phase sin waveforms as shown in FIG. 6. A value of the smaller inter-phase voltage Vy alternatively changes from 0% to 100% and from 100% to 0% of a value of the biggest inter-phase voltage Vx.

A memory in the controller 9 has a map keeping a relation between the rotor angle and the relative duty ratio Dz in order to decide the smaller inter-phase voltage Vy. Relative duty ratio Dz, which is equal to Dy/Dx, shows a relative amplitude ratio between smaller inter-phase voltage Vy and the biggest inter-phase voltage Vx. The half-bridge consisting of the PWM leg is PWM-switched with PWM duty ratio Dz.

Controller 9 reads the relative duty ratio Dz from the map in accordance with the detected rotor angle θ. The map memorizes each relative duty ratio Dz in each rotary angle. The upper arm switches 11, 21 and 31 of the PWM legs are PWM-switched with the relative duty ratio Dz. The lower arm switches 12, 22 and 32 of the PWM leg are complimentary PWM-switched with the relative duty ratio 1-Dz. Three phase voltages Vu, Vv and Vw are hereby decided by only PWM-switching of one phase leg of three-phase inverter 4.

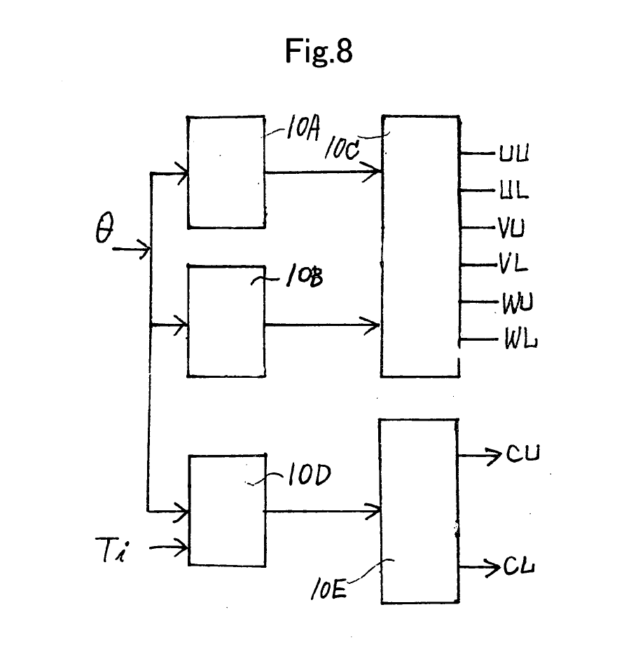

FIG. 8 shows a part of a block diagram of controller 9. Controller 9 has a stage-decision circuit 10A, wave-generation circuits 10B and 10D and PWM signal generation circuits 10C and 10E. The stage-decision circuit 10A decides the present stage in accordance with the detected rotor angle θ. The map shown in FIG. 4 in the memory is used in the decision. The wave-generation circuit 10B generates a PWM signal with relative duty ratio Dz for the switched leg in accordance with the rotor angle θ. PWM signal generation circuit 10C generates PWM-gate voltages UU, UL, VU, VL, WU and WL in accordance with the decided stage, the decided PWM signal of the switched leg in each period of 60 degrees.

The wave-generation circuit 10D generates a PWM signal with duty ratio Dx for DC/DC converter 8B. The wave signal of the biggest inter-phase Vx is changed as shown in FIG. 4. The biggest inter-phase Vx is decided in accordance with the detected rotor angle θ and the torque instruction value Ti. The PWM signal generation circuit 10E generates the PWM-gate voltage for DC/DC converter 8B.

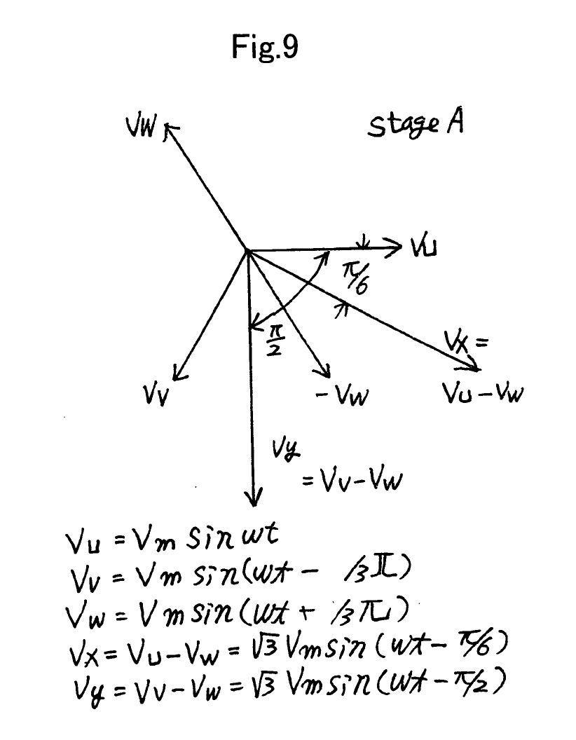

Vectors of voltage Vx and Vy are shown in FIG. 9.

Vu=Vm sin ωt

Vv=Vm(sin ωt−2π/3)

Vw=Vm(sin ωt+2π/3)

Vx=Vu−Vw=1.73*Vm*sin(ωt−2π/3)=1.73*Vm*Dx

Vy=Vv−Vw=1.73*Vm*sin(ωt−π/2)=1.73*Vm*Dy

The PWM ratio Dx of the biggest inter-phase voltage Vx shows the sinusoidal waveform function of sin(ωt−2π/3). The PWM ratio Dy of the smaller inter-phase voltage Vy shows the sinusoidal waveform function of sin(ωt−π/2). Consequently, the relative duty ratio Dz,=Dy/Dx, can be obtained by calculating the following equation.

Dz=sin(ωt−π/2)/sin(ωt−2π/3)

Pre-calculated duty ratio Dx and pre-calculated relative duty ratio Dz are described on the map in the memory. Accordingly, the duty ratio Dx and the duty ratio Dy are searched from the map by using the detected rotor angle θ, which is ωt. The instruction value of the biggest amplitude of the phase voltage Vx,=1.73*Vm, is calculated in accordance with the instruction value of the motor torque. The calculated instruction value of the biggest inter-phase voltage Vx is compared with the detected value of the DC-link voltage Vx.

The Duty ratio of the converter 8 can be feedback-controlled by the result of the comparison. Furthermore, the upper arm switches 11, 21 and 31 of the PWM legs are switched by the PWM method with the relative duty ratio Dz. Each of the PWM-switched lower arm switches 12, 22 and 32 are complimentary switched with the relative duty ratio which is 1-Dz.

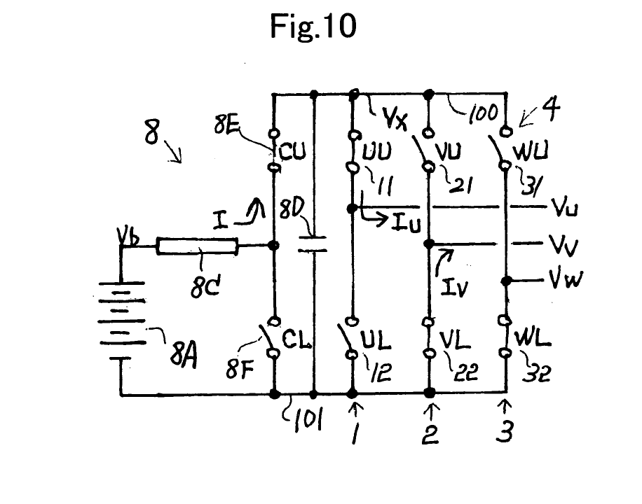

One arranged embodiment of the motor-driving apparatus with the SPSM is explained referring to FIGS. 10-13. FIGS. 10-12 shows a circuit diagram of the motor-driving circuit for driving the three-phase motor each. The apparatus has the three-phase inverter 4 and the converter 8. Three-phase inverter 4 and boost converter 8 shown in FIG. 10 are same as the inverter 4 and the converter 8 shown in FIG. 2.

The converter 8 has the upper switch 8E and the lower switch 8F connected to series. A connecting point between two switches 8E and 8F is connected a positive terminal of battery 8A through reactor 8C. Smoothing capacitor 8D connects between two DC link lines 100 and 101. The well-known chopper-type converter 8 is a bi-directional boost/down type DC/DC converter, which outputs a boost voltage Vx to three-phase inverter 4 and outputs a down voltage Vb to battery 8A.

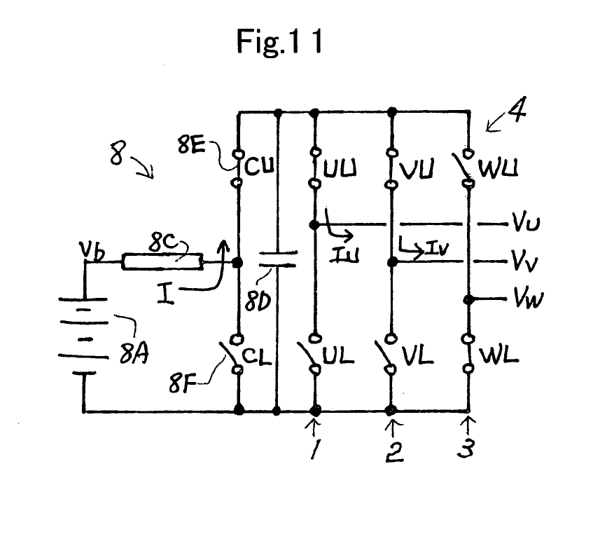

An operation of the above motor-driving circuit is explained as bellows. FIGS. 10-12 show the operation in the stage A. U-phase leg 1 and W-phase leg 3 are the fixed legs. V-phase leg 2 is the PWM leg. In FIG. 10, the switches 8E, 11, 22 and 32 are turned on. The boost voltage Vx supplies current Ito the switch 11. Current I is equal to U-phase current Iu. The switch 22 supplies V-phase current Iv being the free-wheeling current. In FIG. 11, the switches 8E, 11, 21 and 32 are turned on. The boost voltage Vx supplies the current Ito the switches 11 and 21. Accordingly, Current I is equal to the sum of U-phase current Iu and V-phase current Iv.

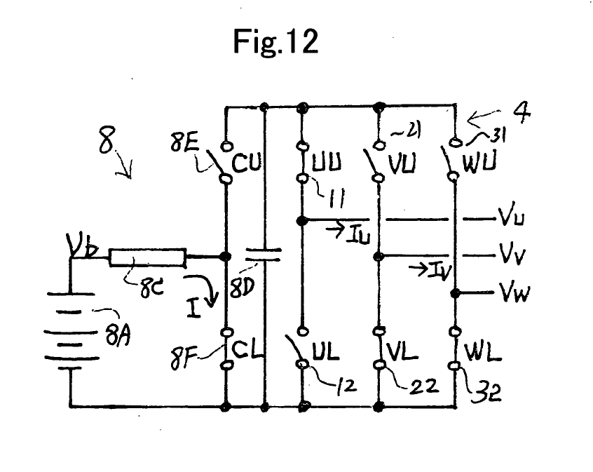

In FIG. 12, the switches 8F, 11, 22 and 32 are turned on. Reactor 8C accumulates the magnetic energy. Smoothing capacitor 8D supplies U-phase current Iu. However, V-phase upper switch 21 is turned off, when the switch 8F is turned on. Smoothing capacitor 8D does not need to supply V-phase current Iv. Accordingly, a voltage drop of smoothing capacitor 8D is reduced.

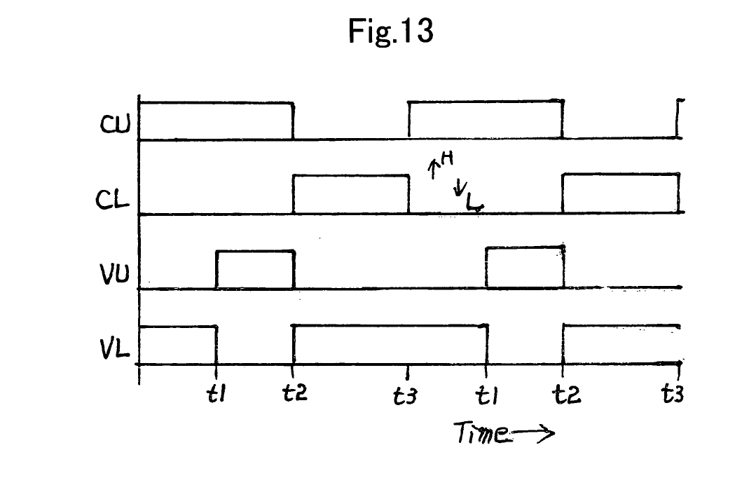

FIG. 13 shows a timing chart showing an operation of converter 8 and the switched leg of the inverter 4. In the period from t1 to t2 in the output period of converter 8 from t3 to t2, the upper switch 21 of the switched leg is turned on. Accordingly, the smoothing capacitor 8D can become small. Furthermore, the upper switch 21 of the switched leg is turned off at the same time when the upper switch 8E of the converter 8 is turned off accordingly, the voltage ripple is reduced.

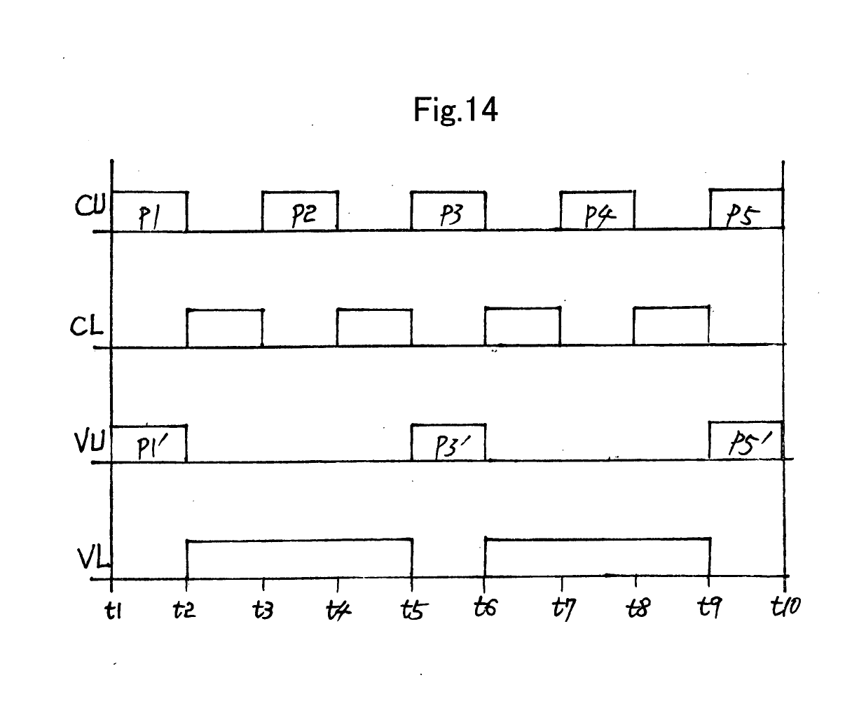

Another arranged embodiment of the motor-driving apparatus with the SPSM is explained referring to FIG. 14. In this embodiment, the upper switch 21 of the switched leg is turned-on in the period when upper switch 8E is turned on. Consequently, the turning-on periods of the upper switch 21 of the switched leg is overlapped with the turning-on periods of upper switch 8E partially.

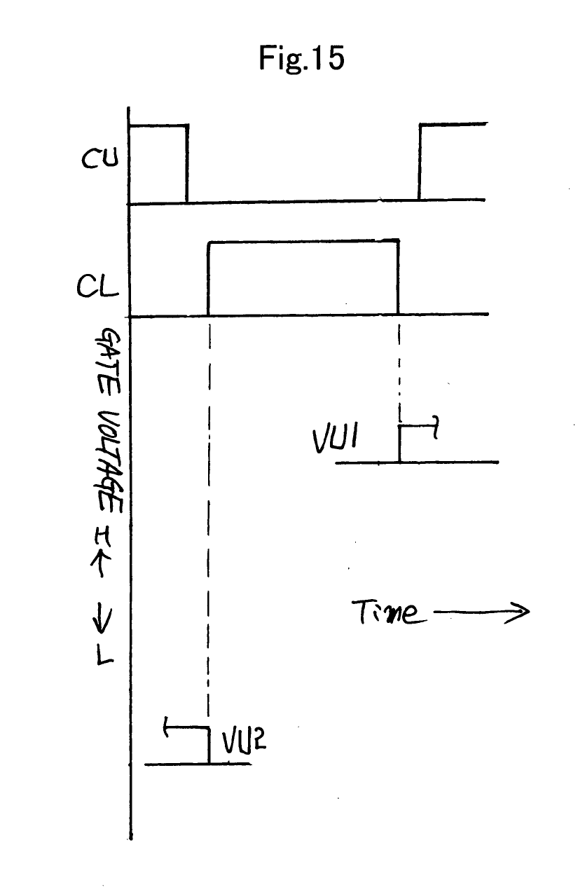

In FIG. 14, turning-on periods of the upper switch 21 of the switched leg is overlapped with the odd turning-on periods of upper switch 8E. If upper switch 21 of the switched leg has a small duty-ratio, gate pulse P3′ is further cancelled. If upper switch 21 of the switched leg has larger duty-ratio, gate pulse voltage VU overlapped with even gate pulse voltage CU is further added. Another arranged embodiment of the motor-driving apparatus with the SPSM is explained referring to FIG. 15. FIG. 15 shows a timing chart showing a relative timing relation between the gate voltages of the inverter and the converter. The gate voltage CU is applied to the upper switch 8E. The gate voltage CL is applied to the lower switch 8F. The biggest inter-phase voltage Vx is changed by the gate voltage CL. The upper switch 21 employs one of two gate voltages VU1 and VU2.

The gate voltages VU1 rises up at the essentially same timing as the falling-down timing of the gate voltage CL. As the result, the voltage ripple of the line 100 is reduced. Because the increasing voltage Vx of the line 100 by the turning-off of the lower switch 8F is reduced by the turning-on of the upper switch 21. The gate voltages VU2 fall down at the essentially same timing as the rising-up timing of the gate voltage CL. As the result, the voltage ripple of the line 100 is reduced. Because the decreasing voltage Vx of the line 100 by the turning-on of the upper switch 8F is reduced by the turning-off of the upper switch 21.

Consequently, in this arranged embodiment, the upper switches 11, 21 and 31 of the inverter 4 are turned on at the essentially same timing as the turning-off timing of the lower switch 8F. In the other embodiment, the upper switches 11, 21 and 31 of the inverter 4 are turned off at the essentially same timing as the turning-on timing of the lower switch 8F. As the result, the noise of the line 100 and the switching loss of the upper switches of the inverter 4 are reduced.

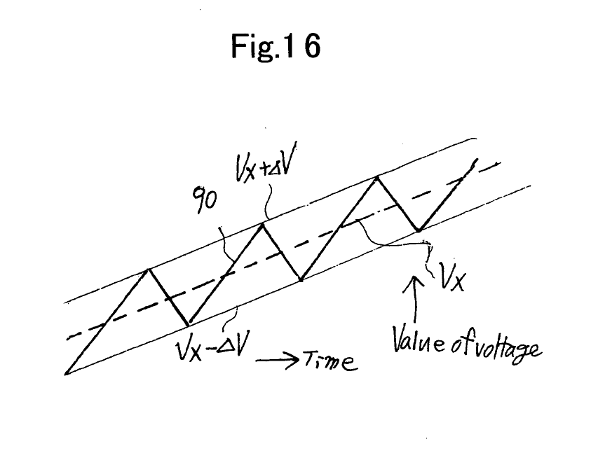

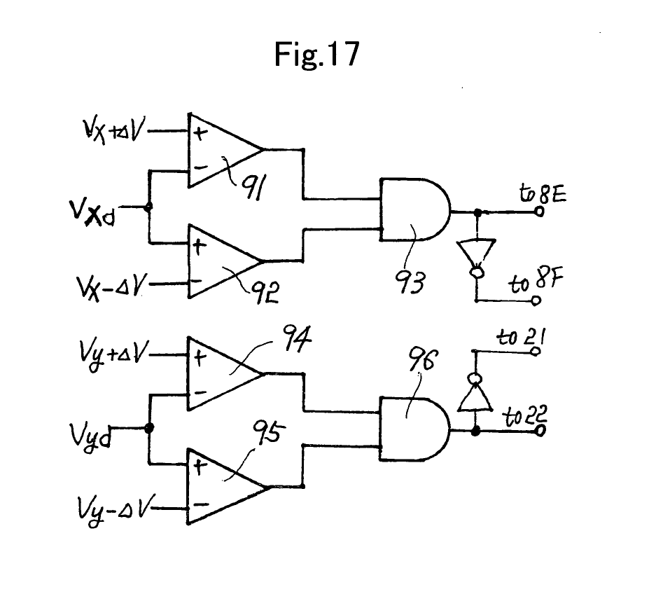

Another arranged embodiment of the motor-driving apparatus with the SPSM is explained referring to FIGS. 16-17. FIG. 16 shows principle of the error-following PWM method, which is one kind of the PWM method. It is called the hysteresis band PWM method. This error-following PWM method can be employed to generate the biggest inter-phase voltage Vx and smaller inter-phase voltage Vy instead of the conventional PWM method having the PWM carrier signal with a constant frequency.

In FIG. 16, a broken line shows an instruction value of the biggest inter-phase voltage Vx. Two real lines Vx+ΔV and Vx−ΔV are formed at both side of broken line Vx. DC/DC converter 8 outputs the biggest inter-phase voltage Vx within the two voltages Vx+ΔV and Vx−ΔV.

FIG. 17 shows a comparator circuit of the error-following PWM method. Detected value Vxd of the biggest inter-phase voltage Vx is compared with Vx+ΔV and Vx−ΔV by the comparators 91 and 92. The AND gate 93 controls the upper switch 8E shown in FIG. 10. Similarly, the detected value Vyd of the smaller inter-phase voltage Vy is compared with Vy+ΔV and Vy−ΔV by the comparators 94 and 95. The AND gate 96 controls the upper switch 21 of the switched leg 2 shown in FIG. 10.

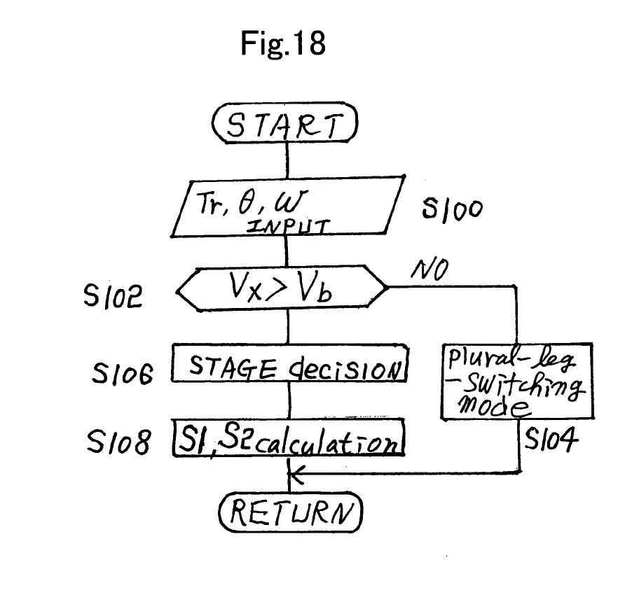

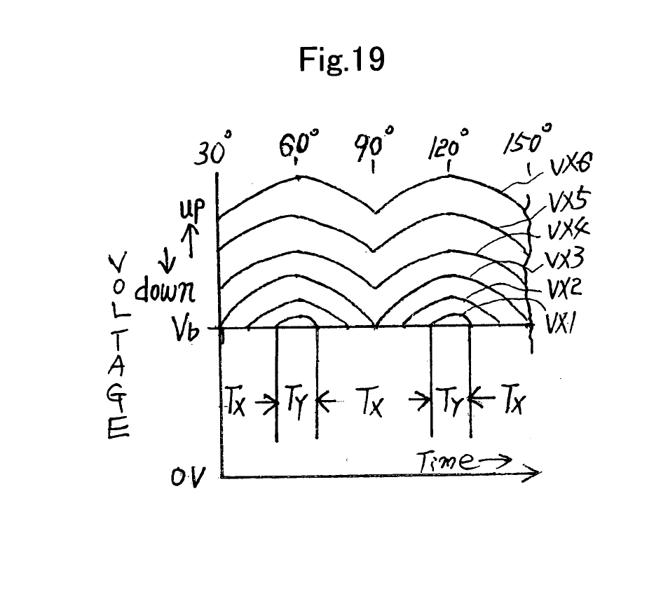

Another arranged embodiment of the motor-driving apparatus with the SPSM is explained referring to FIG. 18 and FIG. 19. The boost converter 8 outputs the biggest inter-phase voltage Vx which is higher than battery voltage Vb. However, boost converter 8 can not output the biggest inter-phase voltage Vx which is lower than battery voltage Vb. It means that the SPSM can not be used for the motor-driving apparatus, when the motor torque or the rotation speed is smaller than a predetermined value.

In other words, the biggest inter-phase voltage Vx is a function value which changes by the motor torque instruction value Tr and the rotation speed ω. The biggest inter-phase voltage Vx is almost proportional to the motor torque instruction value Tr and the rotation speed ω. As the result, the SPSM can be not operated if the calculated biggest inter-phase voltage Vx is smaller than a predetermined value. Consequently, the motor-driving apparatus, which often outputs a small torque at a low rotation speed, can not be operated by the SPSM. The solution is explained hereinafter.

FIG. 18 shows a flow-chart showing a control operation of the motor-driving apparatus with the SPSM. In FIG. 18, the torque instruction value Tr, the rotor angle θ and the rotation speed of the rotor ω are detected at step S100. Next, the biggest inter-phase voltage Vx is calculated in accordance with the torque instruction value Tr, the rotor angle θ and the rotation speed of the rotor ω at step S102.

The controller 9 has a table showing a relation among the biggest inter-phase voltage Vx, the torque instruction value Tr, the rotor angle θ and the rotation speed of the rotor ω. Furthermore, it is judged whether or not the biggest inter-phase voltage Vx is larger than the battery voltage Vb at step S102. A plural-leg-switching mode is selected when the biggest inter-phase voltage Vx is not larger than the battery voltage Vb. In the plural-leg-switching mode, the conventional PWM-switching method, of which two legs or three legs are PWM-switched, is executed at step S104.

In step S102, a single-leg-switching mode is selected when the biggest inter-phase voltage Vx is larger than the battery voltage Vb. The control of the single-leg-switching mode is executed at step S106 and S108. At step S106, one of the stages A-F shown in FIG. 6 is selected in accordance with the detected rotor angle θ. The controller 9 has a table showing a relation between the stage number A-F and the detected rotor angle θ.

Next, at step S108, the gate signals 51 and S2 are calculated in accordance with the torque instruction value Tr, the rotation speed of the rotor ω and the rotor angle θ. The gate signals 51 shows a duty ratio of the converter 8. The gate signals S2 shows a duty ratio of the switched leg of the inverter 4. The controller keeps a relation among gate signals 51 and S2, torque instruction value Tr, the rotation speed of the rotor ω and the rotor angle θ.

The duty ratio of the switched-leg of the inverter 4 is further explained. The switched leg outputs the smaller inter-phase voltage Vy. In order to output the smaller inter-phase voltage Vy, a relative duty ratio Dz of the switched leg is calculated in accordance with the detected rotor angle θ and the relation between the rotor angle θ and relative duty ratio Dz. The relative duty ratio Dz is proportional to the ratio between the value Vy and the value Vx. The decided relative duty ratio Dz of the switched leg is given to the upper switch of the switched leg. The decided relative duty ratio 1-Dz of the switched leg is given to the lower switch of the switched leg. The lower switch of the switched leg has the opposite motion to the upper switch of the switched leg.

FIG. 19 shows several waveforms of the biggest inter-phase voltage Vx. In FIG. 19, the biggest inter-phase voltages Vx1, Vx2, Vx3, Vx4, Vx5 and Vx6 have different amplitudes each other. These waveforms of the biggest inter-phase voltages are essentially equal to the waveform of the biggest inter-phase voltage Vx shown in FIG. 7. However, the amplitudes of the voltages Vx1, Vx2, Vx3, Vx4, Vx5 and Vx6 are different each other because the instruction values of the motor torque are different each other. The period Ty is a period when the voltage Vx1 is higher than battery voltage Vb. The period Tx is a period when the voltage Vx1 is lower than battery voltage Vb. The SPSM is operated in the period Ty. The conventional PWM-switching method is operated in the period Tx.

For example, when the biggest inter-phase voltage Vx is higher value, which is 231V-700V, than battery voltage Vb, which is 230V, the SPSM is operated. As the result, the motor-driving apparatus of the embodiment can control the motor even though the torque and the rotation speed are small.

### The Embodiment 2

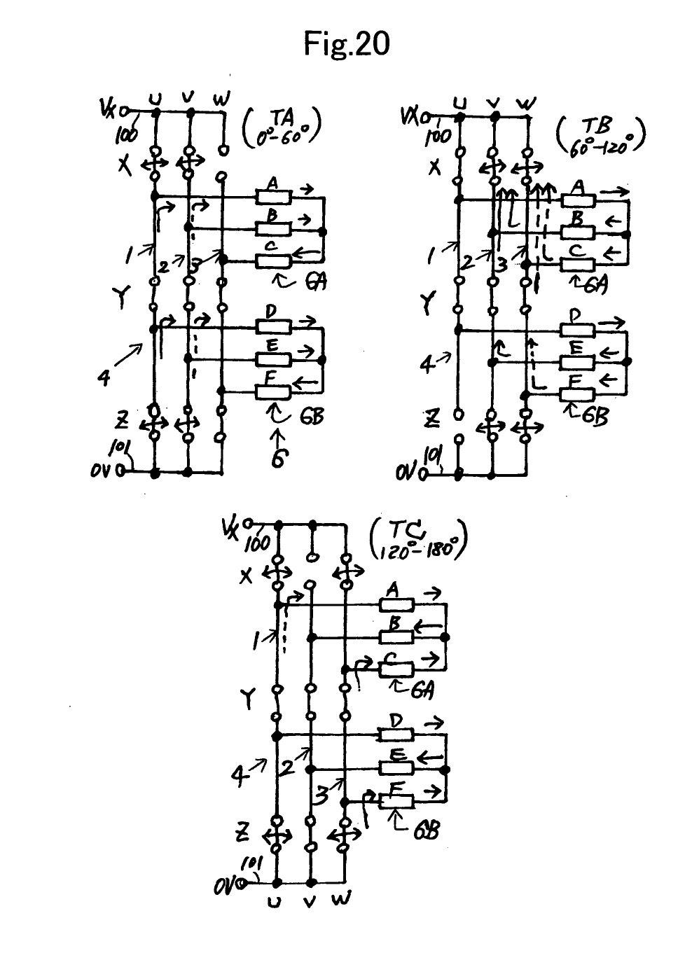

FIG. 20 shows a circuit diagram showing the SPSM-operated motor-driving apparatus driven with the series-parallel-changing method (SPCM). FIG. 20 shows a nine switch inverter 4 driving the variable-speed three-phase motor 6, but illustration of the boost DC/DC converter explained in the embodiment 1 is abbreviated. The biggest inter-phase voltage Vx as the DC-link voltage is applied to the nine-switch inverter 4. The three-phase motor 6 has two three-phase windings 6A and 6B. The three-phase winding 6A with the Y-connection has a U-phase winding A, a V-phase winding B and a W-phase winding C. The three-phase winding 6B with the Y-connection has a U-phase winding D, a V-phase winding E and a W-phase winding F.

The nine-switch inverter 4 shown in FIG. 20 consists of three legs 1-3 connected in parallel. Each of the legs 1-3 has an upper switch X, a middle switch Y and a lower switch Z, which are connected to series. In the other words, the U-phase leg 1 consists of the upper switch UX, the middle switch UY and the lower switch UZ. The V-phase leg 2 consists of the upper switch VX, the middle switch VY and the lower switch VZ. The W-phase leg 3 consists of the upper switch WX, the middle switch WY and the lower switch WZ. Three upper switches X and three lower switches Z are connected to the DC/DC converter through the high potential line 100 and the low potential line 101. The three-phase winding 6A is connected between the three upper switches X and the three middle switches Y. The three-phase winding 6B is connected between the three middle switches Y and the lower switches Z.

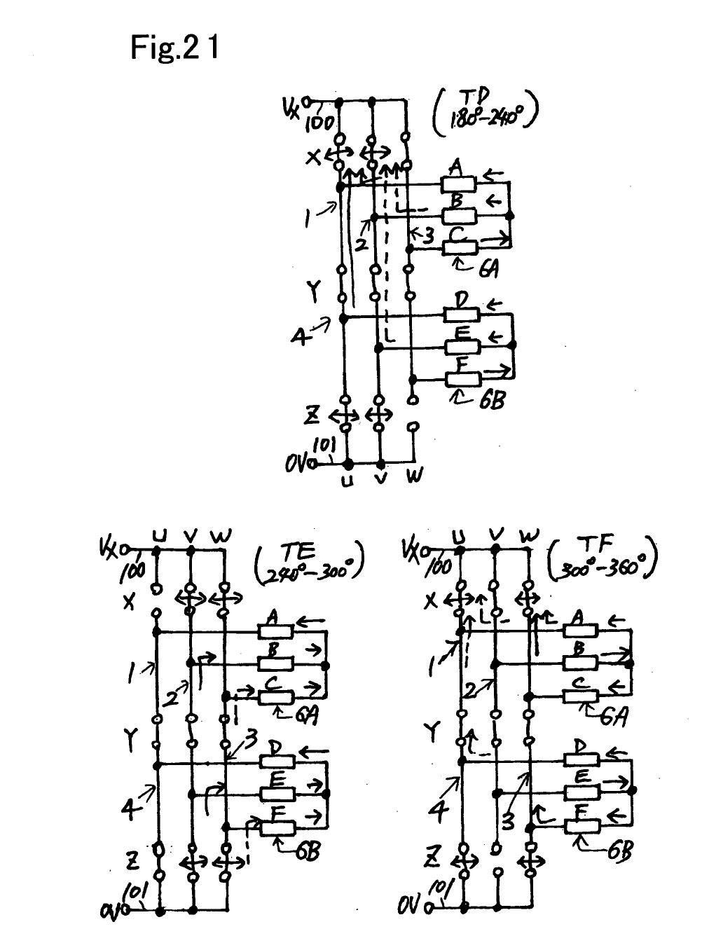

A parallel operation of the nine-switch inverter 4 is explained referring to FIGS. 20-21. The parallel operation has six periods TA-TF. FIG. 20 illustrates three states of the inverter 4 in the periods TA, TB and TC. FIG. 21 illustrates three states of the inverter 4 in the periods TD, TE and TF. Each of the periods TA-TF is a period having the electric angle of 60 degree (π/3). Two three-phase voltages applied to the windings 6A and 6B have the sinusoidal waveform shown in FIG. 6. In the periods TA-TF, three middle switches Y are turning on in the parallel operation. The upper switch X and the lower switch Z of the same phase have an opposite state one another. For example, the switch UX is turned on, when the switch UZ is turned off. The switch UX is turned off, when the switch UZ is turned on. By this motion, short-cut currents are protected.

The period TA is a period from 0 degree to 60 degree. The switch WZ is always turned on. In a first half of the period TA (0 degree-30 degree), the switch VX is always turned on. In a second half of the period TA (30 degree-60 degree), the switch UX is always turned on. The period TB is a period from 60 degree to 120 degree. The switch UX is always turned on. In a first half of the period TB (60 degree-90 degree), the switch WZ is always turned on. In a second half of the period TB (90 degree-120 degree), the switch VZ is always turned on. The period TC is a period from 120 degree to 180 degree. The switch VZ is always turned on. In a first half of the period TC (120 degree-150 degree), the switch UX is always turned on. In a second half of the period TC (150 degree-180 degree), the switch WX is always turned on. The period TD is from 180 degree to 240 degree.

The switch WX is always turned on. In a first half of the period TD (180 degree-210 degree), the switch VZ is always turned on. In a second half of the period TD (210 degree-240 degree), the switch UZ is always turned on. The period TE is a period from 240 degree to 300 degree. The switch UZ is always turned on. In a first half of the period TE (240 degree-270 degree), the switch WX is always turned on. In a second half of the period TE (270 degree-300 degree), the switch VX is always turned on. The period TF is a period from 300 degree to 360 degree. The switch VX is always turned on. In a first half of the period TF (300 degree-330 degree), the switch UZ is always turned on. In a second half of the period TF (330 degree-360 degree), the switch WZ is always turned on.

Two three-phase currents supplied to the three-phase windings 6A and 6B are changed in order. The changing timings are shown in FIG. 4. In the other words, three upper switches X and the three lower switches Z are driven with the timing scheme shown in FIGS. 3 and 4. As the result, only two switches of nine switch inverter 4 are PWM-switched at a time so as to generate the three-phase sinusoidal wave-form in the parallel operation. Real lines with an arrow in the inverter 4 shown in FIGS. 20-21 show free-wheeling currents in the first half of the periods TA-TF. Broken lines with an arrow in the inverter 4 shown in FIGS. 20-21 shows free-wheeling currents in the second half of the periods TA-TF. The inverter 4 supplies the same three-phase voltage to both three-phase windings 6A and 6B.

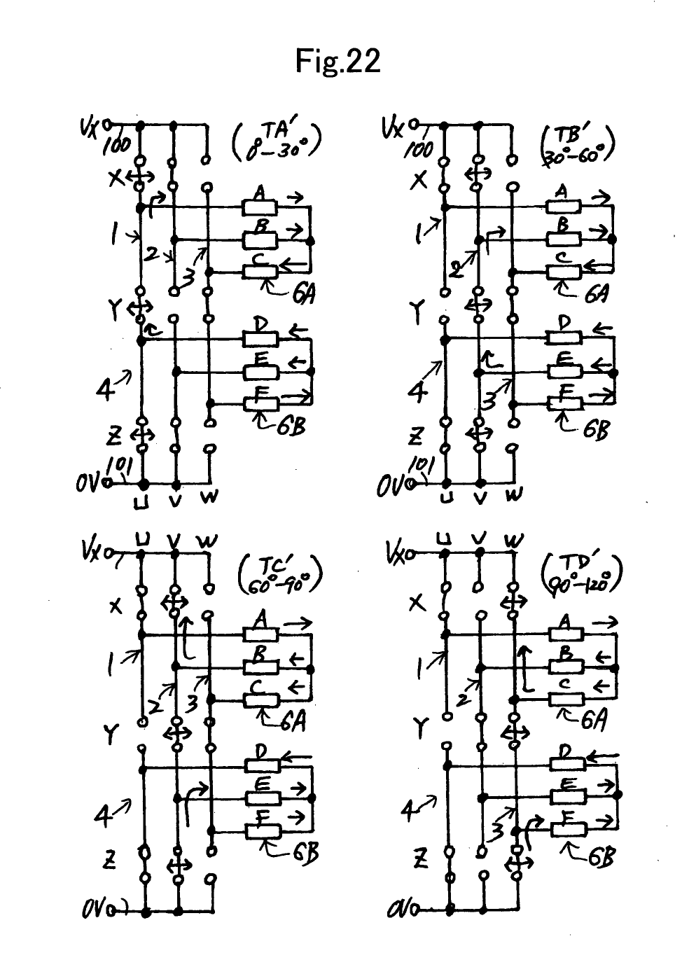

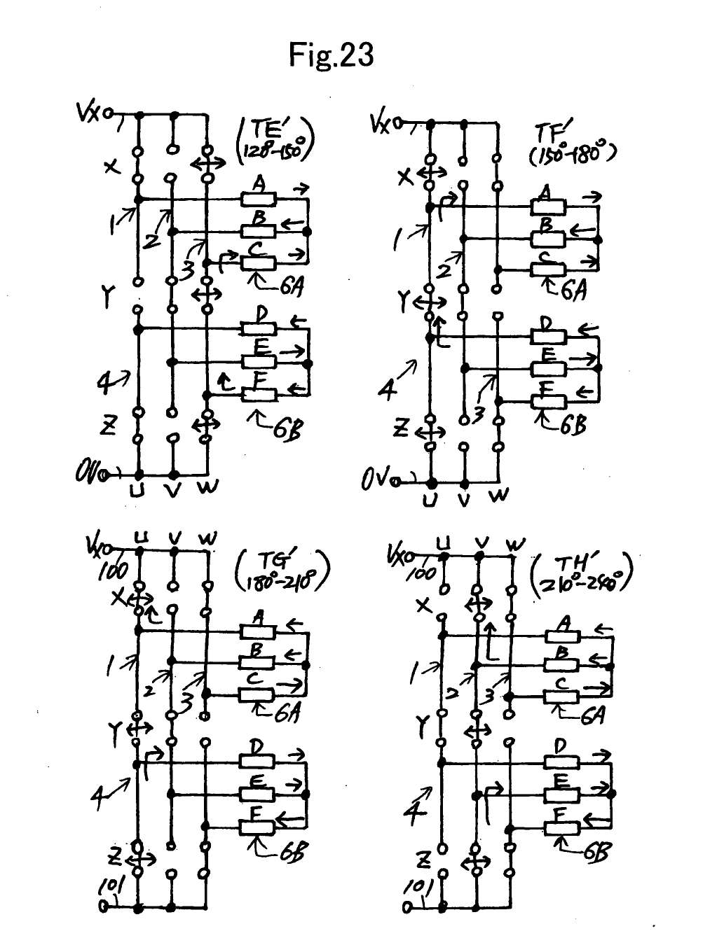

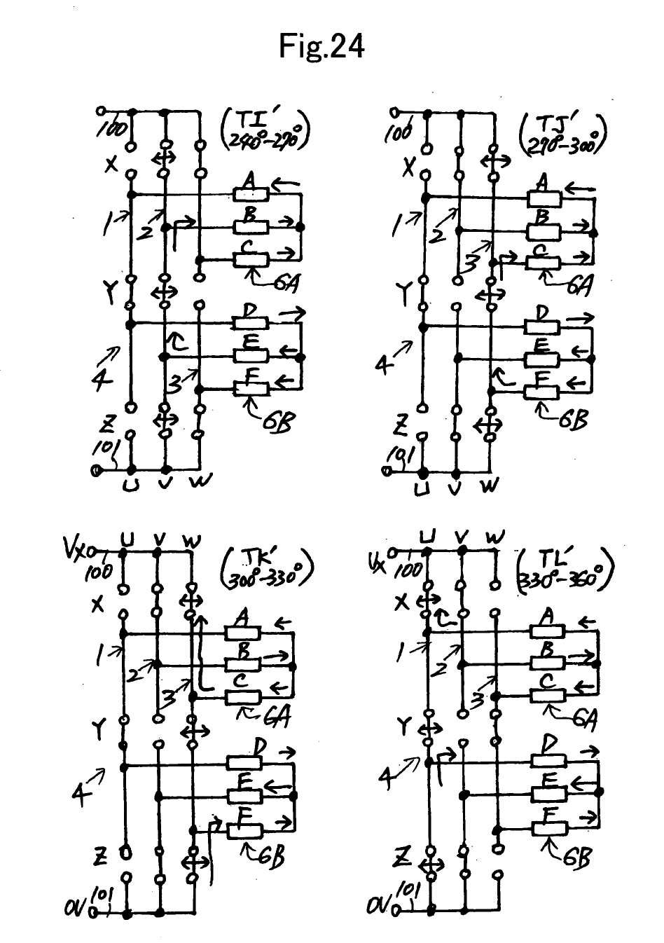

A series operation of the nine-switch inverter 4 is explained referring to FIGS. 22-24. FIG. 22 illustrates four states of the inverter 4 in the periods TA′, TB′, TC′ and TD′. FIG. 23 illustrates four states of the inverter 4 in the periods TE′, TF′, TG′ and TH′. FIG. 24 illustrates four states of the inverter 4 in the periods TI′, TJ′, TK′ and TL′. Each of twelve periods TA′-TL′ is a period having the electric angle of 30 degree. The three-phase voltages applied to the windings 6A and 6B are shown in FIG. 6. In the periods TA′-TL′, one middle switch Y is always turned on. The leg with the turned-on middle switch Y is called as the fixed leg. Another one leg of three legs 1-3 has the turned-on upper switch X and the turned-on lower switch Z.

The leg with the turned-on upper switch X and the turned-on lower switch Z is called the fixed leg, too. The other one leg of three legs is PWM-switched. Combination of the two fixed legs and the one switched leg is changed in order. In the period TL′ and TA′, U-phase leg 1 is PWM-switched. The switches VX, VZ and WY are turned on. In the periods TB′ and TC′, V-phase leg 2 is PWM-switched. The switches UX, UZ and WY are turned on. In the periods TD′ and TE′, W-phase leg 3 is PWM-switched. The switches UX, UZ and VY are turned on. In the periods TF′ and TG′, U-phase leg 1 is PWM-switched. The switches WX, WZ and VY are turned on. In the periods TH′ and TI′, V-phase leg 2 is PWM-switched. The switches WX, WZ and UY are turned on. In the periods TJ′ and TK′, W-phase leg 3 is PWM-switched. The switches VX, VZ and UY are turned on.

As the result, the inverter 4 connects two three-phase windings 6A and 6B to series. Three-phase windings 6A and 6B are driven with the SPSM explained in the embodiment 1. The inverter 4 supplies the same three-phase current to both of the three-phase windings 6A and 6B connected to series. Each of real lines with an arrow in the inverter 4 shown in FIGS. 22-24 shows free-wheeling currents in the periods TA′-TL′.

The SPCM (series-parallel-changing method) with the nine switch inverter 4 has simple structure. Furthermore, the nine switch inverter 4 driven with both of the SPCM and the SPSM reduces the PWM-switched transistors switched at the same period. Only two transistors are PWM-switched at the same period, even though the inverter 4 has nine transistors. The series-parallel-changing method with the nine-switch inverter 4 shown in FIGS. 20-24 can be adopted by the other three-phase inverter switched with the other known switching method. For example, the SPCM inverter can be switched with the three-phase PWM method or the spontaneous space vector method or the two-phase modulation method. In the parallel operation, all middle switches are turned on. Three upper switches X and three lower switches Z are switched with these known switching methods adopted for the conventional six-switch three-phase inverter. In the series operation, at least one middle switch is turned off. At least another one middle switch is turned on. The currents of the nine-switch inverter flows through the second three-phase winding 6B after flowing through the first three-phase winding 6A.

(A Turn-Number-Changing Method)

The important aspect of the above series-parallel-changing method (SPCM) of the nine-switch inverter 4 is explained. The three-phase current of the three-phase winding 6B in the series-connection shown in FIGS. 22-24 flows oppositely in comparison with the three-phase current of the three-phase winding 6B in the parallel-connection shown in FIGS. 20-21. In this embodiment 2, the U-phase windings A and D are wound on the same stator poles. Furthermore, a turn number of U-phase winding A is different from a turn number of U-phase winding D. Current directions of U-phase windings A and D connected in parallel as shown in FIGS. 20-21 are same.

Accordingly, three current directions of U-phase windings A and D connected to series as shown in FIGS. 22-24 are opposite one another. Relation between V-phase windings B and E are same as the above U-phase windings A and D. Relation between the W-phase windings C and F are same as the above U-phase windings A and D, too. For example, U-phase winding A has 300 turns and the U-phase winding D has 200 turns. In FIGS. 20-21, the parallel-connected windings A and D are mostly equivalent to a U-phase winding with 250 (=(300−200)/2) turns. In FIGS. 22-24, the series-connected U-phase winding A and D are mostly equivalent to a U-phase winding with 100 (=300−200) turns. After all, it is considered that the turns of the winding can be changed equivalently with the SPCM (series-parallel changing method) is realized by employing the nine-switch inverter 4, when the two phase windings with same phase have different turn number one another.

(A Pole-Number-Changing Method)

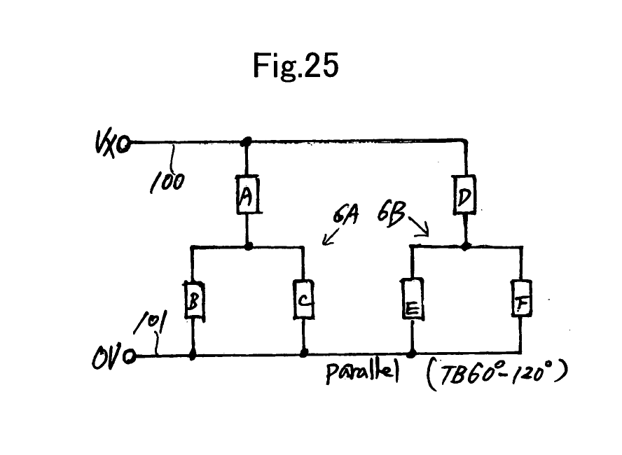

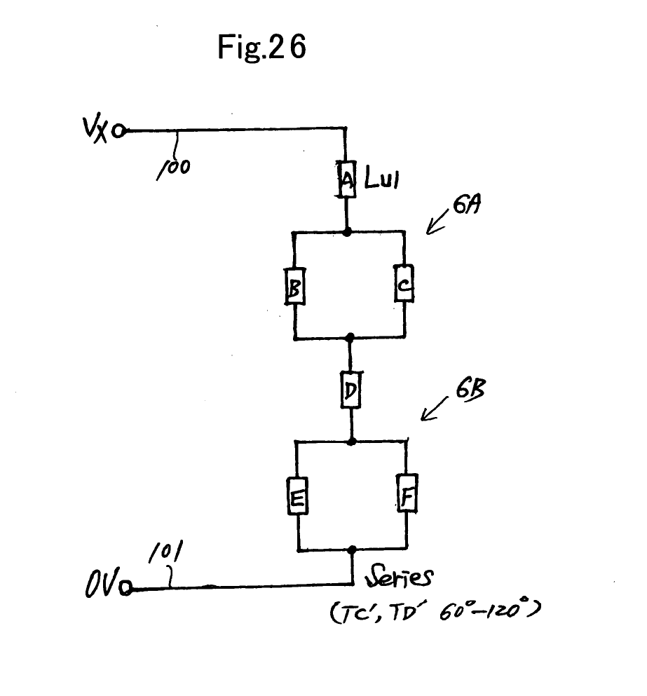

Another method for solving the current-direction-changing problem of the second inverter 6B is explained referring to FIGS. 25-30. This method is called the pole-number-changing method. FIG. 25 is an equivalent circuit view showing the parallel connection of two three-phase windings 6A and 6B shown in FIGS. 20-21 for the period TB. FIG. 26 is an equivalent circuit view showing the series connection of two three-phase windings 6A and 6B shown in FIGS. 22-24 for the periods TC′ and TD′.

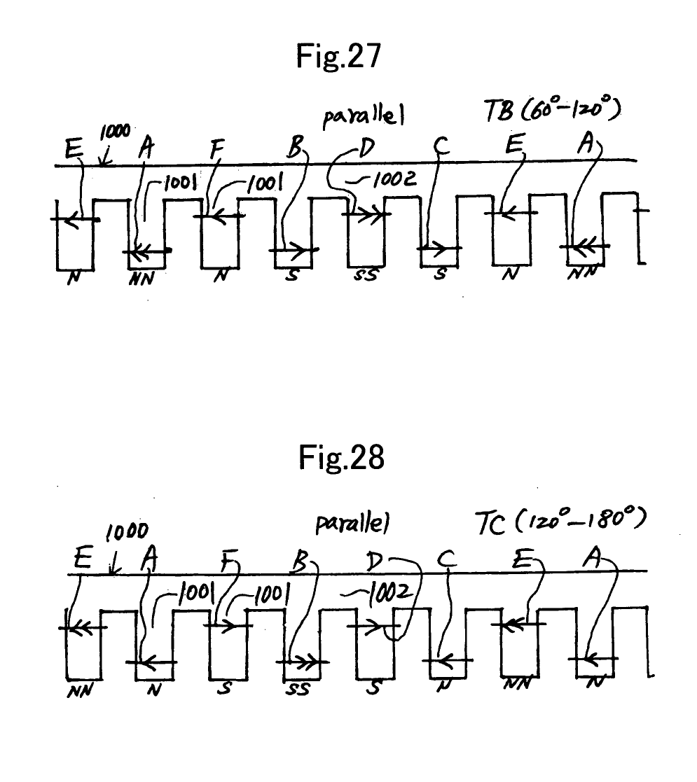

In the pole-number-changing method, each one of six phase windings A-F having an equal turn number each are wound around each one stator poles (stator tooth) respectively as shown in FIGS. 27-30. In FIGS. 27-28, each one of three phase windings A-C of the three-phase winding 6A is wound around each one of odd stator poles in order. Similarly, each one of three phase windings D-F of the three-phase winding 6B is wound around each one of even stator poles in order.

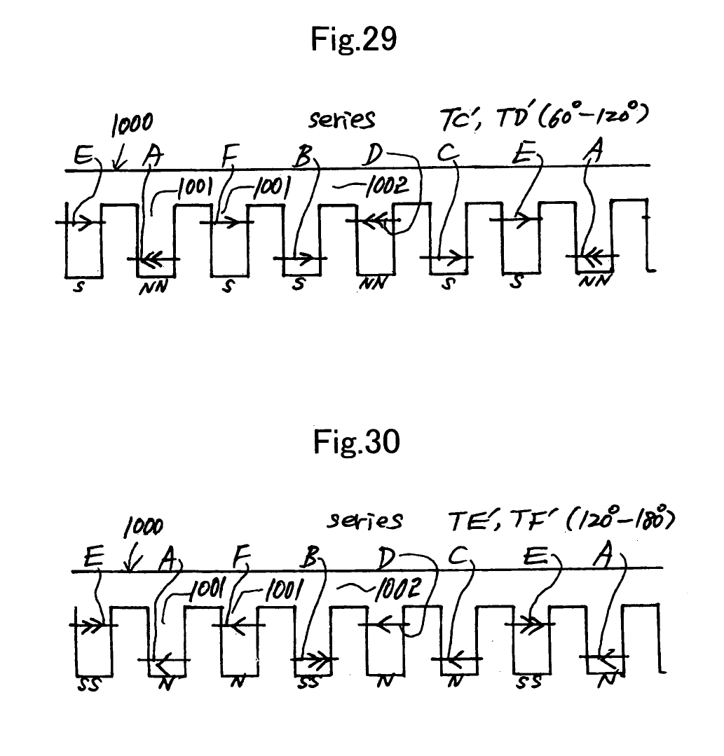

In FIGS. 27-30, a stator core 1000 has teeth 1001, which are stator poles, connected with a back core 1002 each other. The arrow lines A-F illustrated on the teeth 1001 shows six phase windings. The single arrow shows the direction of the current with smaller amplitude. The dual arrow shows the direction of the current with larger amplitude. FIG. 27 shows six phase currents in the period TB (60 degree-120 degree). FIG. 28 shows six phase currents in the period TC (120 degree-180 degree). In FIGS. 27-28, it is considered that the electrical angle of 360 degree is equal to six stator teeth pitches. FIG. 29 shows six phase currents in the periods TC′ and TD′ (60 degree-120 degree). FIG. 30 shows six phase currents in the periods TE′ and TF′(120 degree-180 degree). In FIGS. 29-30, it is considered that the electrical angle of 360 degree is equal to three stator teeth pitches, because the flow directions of three phase currents of the three-phase winding 6B in the series connection are opposite in comparison with them in the parallel connection.

As the result, the pole number of the stator 1000 is doubled by means of changing the connection from the parallel to the series. In the other words, by employing the series connection shown in FIGS. 22-24 and FIGS. 29-30, both of the turn number and the stator pole number of the stator winding are doubled. The above SPCM (stator-pole-changing method) is preferably employed for the induction motor. When the synchronous motor has a rotor which is capable to change a rotor pole number, the above SPCM can be employed. The above pole-number-changing method can change the motor torque largely. The series connection can be adopted at the low rotating speed range preferably. The parallel connection can be adopted at the high rotating speed range preferably.

(The Other Applications Employing the SPCM)

The SPCM can be employed so as to change the motor current, which is proportional to the motor torque, of the variable speed motor including the motor-generator. For example, the motor current of the synchronous motor with the permanent magnets (PM) is decreased at high rotation speed. The PM can increase the current at the high rotation speed by means of employing the series connection shown in FIG. 22-24. The PM does not need to employ the known weaken flux method increasing of the d-axis current in order to increase the motor torque.

According to another application, the series connection of the SPCM shown in FIGS. 22-24 is employed for increasing the motor torque of the motor-generator, when it starts an internal combustion engine. The parallel connection of the SPCM shown in FIGS. 20-21 is employed after starting of the engine. As the result, the generating voltage of the motor-generator is increased, because the equivalent turn number of the stator winding is increased.

Furthermore, the brushless DC motor employing a non-sinusoidal three-phase current waveform can employ the SPCM in order to changing the motor torque. The synchronous reluctance motor (SynRM) and the induction motor (IM) driven with sinusoidal three-phase current waveform can employ the SPCM in order to changing the motor torque. Furthermore, the three-phase motor driven with the other driving method such as the two-phase-modulation method and the spontaneous-space-vector method (SSVM) can employ the SPCM in order to change the motor torque.

The SSVM (spontaneous space vector method) is similar to the SPSM (single-phase-switching method). The SSVM has two PWM-switched legs at one time. The SPSM has one PWM-switched leg at one time. Preferably, the SSVM is employed when the amplitude of the three-phase voltage applied to the motor is smaller than the battery voltage. The SPSM is employed when the amplitude of the three-phase voltage applied to the motor is larger than the battery voltage.

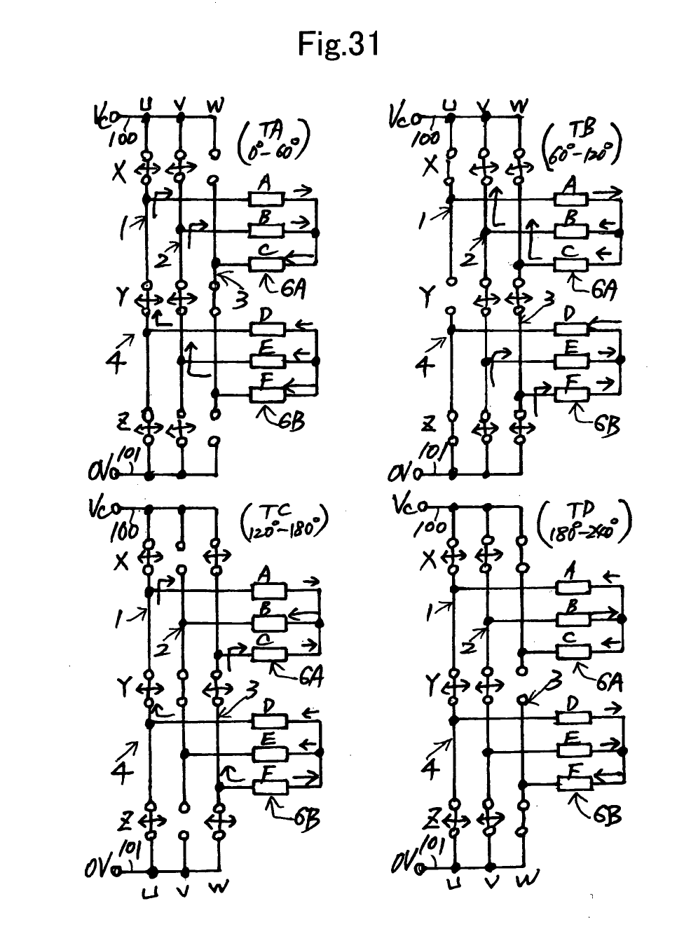

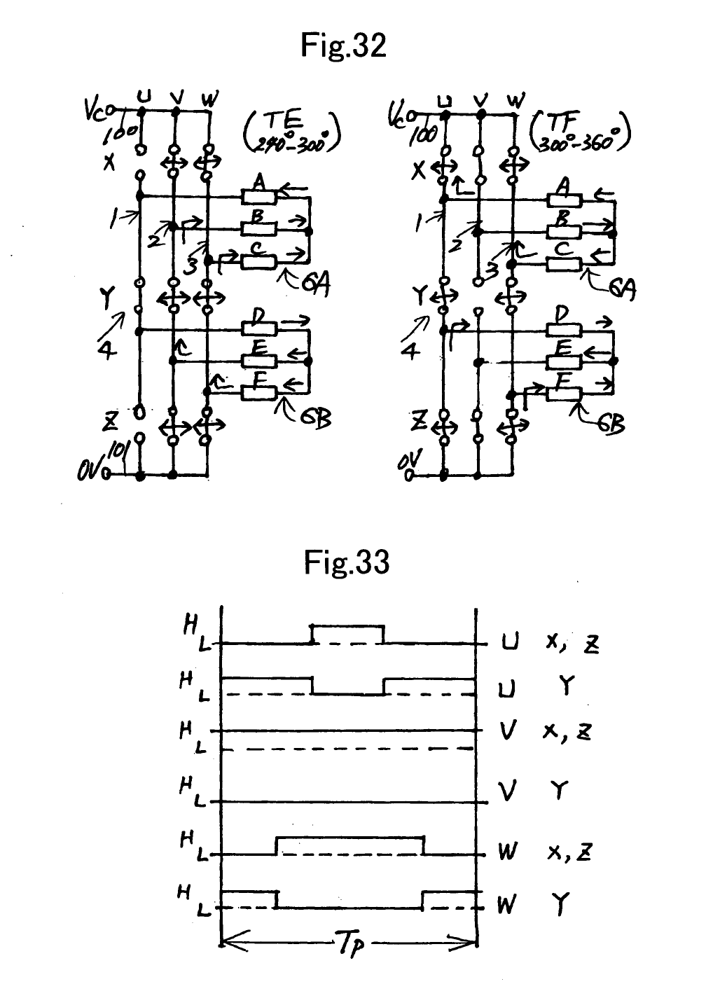

The parallel operation of the nine-switch inverter driven with the SSVM is shown in FIGS. 20-21. The series operation of the nine-switch inverter driven with the SSVM is shown in FIGS. 31-32. FIG. 33 shows one PWM carrier period Tp of the SSVM. The nine wave forms of the gate-voltages applied to the nine switches of the inverter 4 are shown in FIG. 33.

What is claimed is:

1. A motor-driving apparatus for driving a variable-speed three-phase motor comprising:
an inverter (4) applying a three-phase voltage to the motor (6); and
a controller (9) controlling the inverter (4) having three legs (1-3) connected in parallel;
wherein the apparatus has a boost DC/DC converter (8) applying a boost voltage to the inverter (4);
the inverter (4) has one switched leg, a first fixed leg and a second fixed leg;
each of the legs (1-3) has an upper switch (X), a middle switch (Y) and a lower switch (Z) connected to series;
the motor (6) has a first three-phase winding (6A) and a second three-phase winding (6B);
the first three-phase winding (6A) is connected between the three upper switches (X) and the three middle switches (Y);
the second three-phase winding (6B) is connected between the three middle switches (Y) and the three lower switches (Z);
the converter (8) applies a biggest inter-phase voltage (Vx) of the three-phase voltage to the motor (6) via the two fixed legs;
the switched leg applies a smaller inter-phase voltage (Vy) being smaller than the biggest inter-phase voltage (Vx) by means of switching of at least the upper switch (X) and the lower switch (Z);
the controller (9) has a parallel mode and a series mode in a single-leg-switching mode changing the switched leg and the two fixed legs in order;
the three middle switches (Y) are turned on in the parallel mode;
the first fixed leg has the turned-on upper switch (X) and the turned-on lower switch (Z) in the series mode; and
the second fixed leg has the turned-on middle switch (Y) in the series mode.

2. The motor-driving apparatus according to claim 1, wherein the boost DC/DC converter (8) boosts a battery voltage applied from a vehicle battery (7) and applies the boosted biggest inter-phase voltage (Vx) to the inverter (4) driving the motor (6) being a traction motor of a vehicle.

3. A motor-driving apparatus for driving a variable-speed three-phase motor comprising:
an inverter (4) applying a three-phase voltage to the motor (6); and
a controller (9) controlling the inverter (4) having three legs (1-3) connected in parallel;
wherein the apparatus has a boost DC/DC converter (8) applying a boost voltage to the inverter (4);
the inverter (4) has one switched leg, a first fixed leg and a second fixed leg;
each of the legs (1-3) has an upper switch (11, 21, and 31) and a lower switch (12, 22, and 32) connected to series;
the boost DC/DC converter (8) applies a biggest inter-phase voltage (Vx) of the three-phase voltage to the motor (6) via the two fixed legs;
the switched leg applies a smaller inter-phase voltage (Vy) being smaller than the biggest inter-phase voltage (Vx) by means of switching of the upper switch (11, 21, 31) and the lower switch (12, 22, 32);
the controller (9) has a single-leg-switching mode changing the switched leg and the two fixed legs in order;
the first fixed leg has the turned-on upper switch (11, 21, and 31) and the turned-off lower switch (12, 22, and 32) in the single-leg-switching mode;
the second fixed leg has the turned-off upper switch (11, 21, 31) and the turned-on lower switch (12, 22, 32) in the single-leg-switching mode; and
the controller (9) controls amplitude and a waveform of the biggest inter-phase voltage (Vx) in accordance with a value of a motor current and a value of a rotor angle of the motor (6).

4. The motor-driving apparatus according to claim 3, wherein the controller (9) further has a plural-leg-switching mode for controlling the boost DC/DC converter (8) and the inverter (4);
at least two legs (1-3) of the inverter (4) are switched with a PWM method in the plural-leg-switching mode;
the controller (9) selects the single-leg-switching mode when the biggest inter-phase voltage (Vx) is larger than a voltage of the power supply apparatus (7); and
the controller (9) selects the plural-leg-switching mode when the biggest inter-phase voltage (Vx) is smaller than the voltage of the power supply apparatus (7).

5. The motor-driving apparatus according to claim 3, wherein the biggest inter-phase voltage (Vx) has a three-phase-full-wave-rectified wave form; and
the inverter (4) outputs a three-phase sinusoidal voltage of which a frequency is changed in accordance with the rotation speed of the motor (6).

6. The motor-driving apparatus according to claim 3, wherein the boost DC/DC converter (8) consists of a chopper type DC/DC converter (8) with a reactor (8C) and a half bridge of which an upper switch (8E) and a lower switch (8F) are connected to series; and
the controller (9) changes a PWM duty ratio of the boost DC/DC converter (8) in the single-leg-switching mode in accordance with a received torque instruction value (Tr) and a detected rotation speed (ω) of the motor (6).

7. The motor-driving apparatus according to claim 3, wherein the boost DC/DC converter (8) boosts a battery voltage applied from a vehicle battery (7) and applies the boosted biggest inter-phase voltage (Vx) to the inverter (4) driving the motor (6) being a traction motor of a vehicle.

8. The motor-driving apparatus according to claim 3, wherein the motor (6) has permanent magnets fixed to a rotor of the motor (6); and
the boost DC/DC converter (8) applies the biggest inter-phase voltage (Vx), which is larger than a generation voltage of the motor (6), in the single-leg-switching mode.

9. A motor-driving apparatus for driving a variable-speed three phase motor comprising:
an inverter (4) applying a three-phase voltage to the motor (6); and
a controller (9) controlling the inverter (4) having three legs (1-3) connected in parallel;
wherein each of the legs (1-3) has an upper switch (X), a middle switch (Y) and a lower switch (Z) connected to series;
the motor (6) has a first three-phase winding (6A) and a second three-phase winding (6B);
the first three-phase winding (6A) is connected between the three upper switches (X) and the three middle switches (Y);
the second three-phase winding (6B) is connected between the three middle switches (Y) and the three lower switches (Z);
the controller (9) has a parallel mode and a series mode;
the three middle switches (Y) are turned on in the parallel mode;
one of the three legs has the turned-on upper switch (X) and the turned-on lower switch (Z) in the series mode; and
another one of the three legs has the turned-on middle switch (Y) in the series mode.

10. The motor-driving apparatus according to claim 9, wherein the inverter (4) applies two three-phase voltages to the motor (6) driving wheels of a vehicle.

11. The motor-driving apparatus according to claim 9, wherein the first three-phase winding (6A) has a different number of turns from the second three-phase winding (6B).

12. The motor-driving apparatus according to claim 9, wherein the first three-phase winding (6A) is wound around odd numbered stator poles of the motor (6); and
the second three-phase winding (6B) is wound around even numbered stator poles of the motor (6).
